(19) United States
(12) Patent Application Publication
(10) Pub. No.: US 2011/0070469 A1
(43) Pub. Date: Mar. 24, 2011

(54) SUPPLYING POWER FOR A MICRO SYSTEM

(75) Inventors: Dirk Jan Broer, Geldrop (NL); Roel Penterman, Eindhoven (NL); Emiel Peeters, Eindhoven (NL); Ralph Kurt, Eindhoven (NL); David Halter, Eindhoven (NL); Hendrik De Koning, Well Ammerzoden (NL)

(73) Assignee: KONINKLIJKE PHILIPS ELECTRONICS N.V., EINDHOVEN (NL)

(21) Appl. No.: 12/993,104

(22) PCT Filed: May 19, 2009
(86) PCT No.: PCT/IB09/52088

§ 371 Date: Nov. 17, 2010

(30) Foreign Application Priority Data
May 27, 2008 (EP) 08104108.9

(51) Int. Cl. H01M 6/24; H01M 2/38

(52) U.S. Cl. 429/51; 429/105

(57) ABSTRACT

A micro system power supply (1) comprises a compartment (7), at least one ion sink void (51, 52) being separated from the compartment (7) by ion pervious separation means (61, 62), a first electrode (41) being arranged in the ion sink void, and a second electrode (42). Such a micro system power supply (1) allows to provide power for a micro system, such as, e.g., an implantable micro device, a MEMS, a bioMEMS, or the like, wherein the micro system power supply (1) can be comparably efficiently manufactured in a manner to be comparably environmentally friendly disposable.

### FIELD OF THE INVENTION

The invention relates to the field of power supplies suitable for supplying power to a micro system, in particular suitable for supplying power to a microfluidic system, a micro electromechanical system, a micro electromechanical system for medical and health related applications, or an implantable micro device. More specifically it relates to a micro system power supply and a method of supplying power to a micro system.

### BACKGROUND OF THE INVENTION

The importance of micro systems and, in particular, microfluidic systems as a technology with the capability of creating complex, autonomous and low cost analysis systems is increasing. Often, micro electromechanical systems (MEMS) and MEMS for medical and health related applications (bioMEMS) are integrated to perform a predefined action such as pumping, mixing or closing/opening of a micro-channel or a container. Thereby, often a sensor is integrated providing digital information on the presence or absence of an analyte, e.g., a small solid state light emitting diode and a light sensor.

One critical issue to be addressed is the supplying of power to operate such micro systems. Especially when being built as portable handheld devices or as implantable devices for use in areas away from standard power sources, local power sources are needed. This need is presently usually settled by classical battery systems such as lithium batteries. One problem of such battery systems is related to environmental issues as the micro systems often are disposable devices where a built-in standard battery would put load on the environment. To avoid this, also external batteries can be applied that can be demounted and reused or properly disposed. However, often the size of the battery and that of its contact points does not match with the size of the micro system. Also, the power that such batteries deliver usually is an overshoot with respect to the power needed by the micro system. Furthermore, such batteries usually are not stably storable over a long term which can be of particular importance for devices that are used only sporadically.

To overcome at least some of the disadvantages of the battery systems mentioned above, disposable, acid- and/or water activated battery systems using chemical reactions in a cavity have been developed. However, these further battery systems usually are comparably complex to manufacture and usually are not compatible with bioMEMS. E.g., in WO 2006/028347 A1 a battery for applications in disposable DNA chips, lab-on-a-chip and micro fluidics is described that can be activated by a liquid. The battery is based on a paper that includes a chloride cathode material, an anode, a copper layer for current collection, as well as a lower and an upper plastic film maintaining a predetermined gap between the anode, the paper and the copper layer. The battery further has an introduction hole for the liquid and an exhalation hole. Urine or an other (bio)liquid is used to activate the battery. The overall chemical reaction performed by the battery to drive current after the battery is activated by the liquid is described as Mg+2CuCl→MgCl₂+2Cu. Thereby, as soon as contact is provided between the dry system and the liquid, the battery starts to work. However, artificial metal ions or artificial salts are used in the battery which can have a negative impact on the environment when the battery is disposed.

### SUMMARY OF THE INVENTION

It would be advantageous to achieve an autonomously operating alternative micro power supply system which is suitable to be integrated together with MEMS, implantable micro devices, or bioMEMS or similar systems. It would also be desirable to enable an alternative micro system power supply to be comparably easily manufactured. To better address one or more of these concerns, in a first aspect of the invention a micro system power supply is presented that comprises a compartment, at least one ion sink void being separated from the compartment by ion pervious separation means, a first electrode being arranged in the at least one ion sink void, and a second electrode. The term “micro system” and derivations thereof as used herein relate to micrometer or microliter dimension devices also including low centimeter or low centiliter devices.

Such a micro system power supply can provide power generated by reverse electrodialysis. Therefore, a suitable liquid such as, in particular, a bio-liquid as, e.g., blood or urine can be provided into the compartment. As an example, urine usually contains salts wherein Na⁺, K⁺, Mg²⁺, Ca²⁺ and NH₄⁺ commonly occur as cations and Cl⁻, SO₄²⁻, H₂PO₄⁻, HPO₄²⁻ and PO₄³⁻ commonly occur as anions. Driven by the tendency of reducing the difference between the salt concentrations in the compartment and in the at least one ion sink void, ions pass the ion pervious separation means wherein the ion pervious separation means are pervious either for cations or for anions. In this way, a difference between chemical potentials of ion concentrations in the ion sink void and a reference, e.g. the compartment itself, is provided. The first electrode is arranged in the at least one ion sink void and the second electrode is arranged in the reference such that by means of the voltage between the first and the second electrode power can be supplied. Thus, such a micro system power supply allows to provide power for a micro system, such as, e.g., an implantable micro device, a MEMS, a bioMEMS, or the like, wherein the micro system power supply can be comparably efficiently manufactured in a manner to be comparably environmentally friendly disposable. Furthermore, by means of the micro system power supply bio liquids such as in particular body own liquids, e.g., blood or urine, can be used as energy source to operate the micro system power supply. Therefore, the micro system power supply can be self sustainable and can be particularly suitable for integration in biosensing microfluidic devices or, e.g., in implantable drug delivery micro devices.

Preferably, the ion pervious separation means comprise an anion exchange membrane and a cation exchange membrane as well as the at least one ion sink void comprises a first ion sink void and a second ion sink void. Thereby, the first ion sink void is separated from the compartment by the anion exchange membrane and the second ion sink void is separated from the compartment by the cation exchange membrane. Furthermore, the first electrode preferably is arranged in the first ion sink void and the second electrode preferably is arranged in the second ion sink void. With such an arrangement of ion sink voids and exchange membranes, the tendency of reducing the difference between the ion concentrations of a suitable liquid being provided into the compartment and the ion sink voids drives anions to be accumulated in the first ion sink void and cations to be accumulated in the second ion sink void. In this way, the second ion sink void can be the reference with the second electrode such that by means of the voltage between the first electrode being arranged in the first ion sink void and the second electrode being arranged in the second ion sink void power can be supplied.

Suitable anion and cation exchange membranes can be provided as polymeric membranes. For manufacturing a micro system power supply having such polymeric anion and cation exchange membranes, the anion and cation exchange membranes can be photolithographically processed using an ionic photopolymerizable monomer. In more detail, the method for manufacturing the micro system power supply can comprise the steps of:
(i) masking at least one polymeric membrane forming area on a first glass plate;
(ii) providing ultraviolet light and ozone to the first glass plate for forming hydrophobic areas where the first glass plate is not masked;
(iii) removing the mask from the first glass plate;
(iv) arranging a second glass plate adjacent to the first glass plate wherein the first glass plate and the second glass plate are kept at a distance by a spacer;
(v) arranging the ionic photopolymerizable monomer between the first glass plate and the second glass plate adjacent to the at least one polymeric membrane forming area; and
(iv) polymerizing the ionic photopolymerizable monomer.

In this way, the micro system power supply can be comparably efficiently manufactured.

Also, the at least one polymeric membrane forming area can be coated with an adhesive layer before the ionic photopolymerizable monomer is arranged between the first glass plate and the second glass plate which can enhance stability. Furthermore, the steps (i) to (iii) can also be applied to the second glass plate before arranging the second glass plate adjacent to the first glass plate. Still further, a plasticizer or a porogen can be added to the ionic photopolymerizable monomer to increase the diffusion speed of the ions through the resulting polymeric membrane.

In a preferred embodiment of the micro system power supply according to the invention, the anion exchange membrane and the cation exchange membrane are arranged on opposite sides of the compartment. In this way, a physical separation of the first ion sink void and the second ion sink void can easily be realized and the micro system power supply can comparably efficiently be manufactured.

Preferably, an ion sink medium is arranged in the at least one ion sink void. In particular, suitable ion sink media can be liquid. The term “ion sink medium” as used herein relates to any medium being capable of accumulating ions with respect to a medium being arranged in the compartment. In a preferred embodiment, the ion sink medium is a low ionogenic liquid. An ion sink void housing such a low ionogenic liquid, such as, e.g., water, de-ionized water, or distilled water, can be an easy realization of an ion sink allowing operating the micro system power supply.

Preferably, the at least one ion sink void further comprises an inlet for receiving an ion sink medium. Like this, a micro system power supply can be provided wherein the ion sink medium can be filled into the at least one ion sink void at the place of operation of the micro system power supply. Since the ion pervious separation means can be somewhat sensitive for water transport to the compartment, undesired filling of the compartment during storage (prior to the use) of the micro system power supply can be prevented.

In a preferred embodiment, the micro system power supply comprises an electrical circuit being connected to the first electrode and to the second electrode. Such an electrical circuit can be used for efficiently providing the voltage between the first electrode and the second electrode as well as for connecting the micro system power supply to a micro system. The first electrode and the second electrode can preferably be made of platinum. Additionally, also the electrical circuit can be made of platinum.

Preferably, the micro system power supply comprises a first plate, a second plate and a space holder being arranged between the first plate and the second plate. Therein, the compartment, the at least one ion sink void, the ion pervious separation means, the first electrode, and the second electrode are arranged in the interior formed by the first plate, the second plate and the space holder. In this way, a compact realization of the micro system power supply is possible which is comparably convenient to handle. In particular, such a micro system power supply can be designed for the integration in a microfluidic chip.

In a preferred embodiment, the at least one ion sink void is encapsulated by the ion pervious separation means and the compartment is surrounding the at least one ion sink void. In this way, the contact area between the compartment and the at least one ion sink void can be comparably large allowing to increase the power generatable by the micro system power supply.

In a further preferred embodiment, the ion pervious separation means have an uneven structured surface facing the compartment. Like this, the contact area between the compartment and the at least one ion sink void can be comparably large allowing to increase the power generatable by the micro system power supply. The uneven structured surface can have a serpentine shape or can be interdigitated, or the membrane can have serpentine shaped main microchannels.

Preferably, the micro system power supply comprises a plurality of compartments, a plurality of at least one ion sink voids, a plurality of ion pervious separation means, a plurality of first electrodes, and a plurality of second electrodes.

Like this, the overall maximal power generatable by the micro system power supply can be increased.

In one preferred embodiment, the ion pervious separations means are made of an ionic gel. Such ionic gels can be comparably easily applied and allow a comparably efficient manufacture of the micro system power supply.

In another preferred embodiment, the ion pervious separation means are made of a phase separator with a polymer matrix having continuous ducts. The ducts can be clad by ion exchanging groups. Such ion pervious separation means allow an effective and efficient separation of ions.

Preferably, the micro system power supply comprises a salt being arranged in the compartment. Such a salt can enhance the capacity of the micro system power supply.

A further aspect of the invention relates to a micro system power supply rack comprising a plurality of micro system power supplies as described. Such a micro system power supply rack can provide comparably high voltages such that comparably strong power can be supplied by such a micro system power supply rack.

In one preferred embodiment of the micro system power supply rack, the micro system power supplies are arranged side by side. This allows a comparably flat compact arrangement of the micro system power supply rack which can, e.g., be preferred in certain applications.

In another preferred embodiment of the micro system power supply rack, the micro system power supplies are arranged one upon another. Thereby, spacer materials, e.g., porous membranes like paper filled with de-ionized water, can form the ion sinks A cell can be formed using two substrates with ion selective membranes, leaving a cavity as the compartment in which the liquid can be filled. Like this, a compact efficient arrangement of the micro system power supply rack is possible.

Also, the two mentioned embodiments of micro system power supply racks can be combined to result in a particularly advantageous arrangement of the micro system power supply rack depending on its application.

Another further aspect of the invention relates to a method of supplying power to a micro system, comprising the steps of:
(i) providing a compartment being separated from at least one ion sink void by ion pervious separation means;
(ii) providing a first electrode in the at least one ion sink void and a second electrode contacting a reference;
(iii) providing an electrical circuit connecting the first electrode and the second electrode;
(iv) providing an ion sink medium into the at least one ion sink void;
(v) connecting the electrical circuit to the micro system; and
(vi) providing a bio-liquid into the compartment.

Such a method can provide power generated by reverse electrodialysis as described above allowing to provide power for a micro system, such as, e.g., an implantable micro device, a MEMS, a bioMEMS, or the like. Preferably, a salt is arranged in the compartment before the bio-liquid is provided into the compartment. Such a salt can enhance the capacity of the method.

In still another further aspect of the invention, the micro system power supply itself can be used as a biosensor, i.e. to quantify the concentration of a single or of a plurality of specific salts or ions being present in a body fluid.

These and other aspects of the invention will be apparent from and elucidated with reference to the embodiment(s) described hereinafter.

### BRIEF DESCRIPTION OF THE DRAWINGS

The micro system power supply according to the invention and the method of supplying power to a micro system according to the invention are described in more detail hereinbelow by way of exemplary embodiments and with reference to the attached drawings, in which:

FIG. 1 shows a schematic cross sectional view of a first embodiment of a micro system power supply according to the invention;

FIG. 2 shows a schematic cross sectional view of a second embodiment of a micro system power supply according to the invention;

FIG. 3 shows a schematic cross sectional view along the line A-A of the micro system power supply from FIG. 2.

### DETAILED DESCRIPTION OF EMBODIMENTS

In the following description certain terms are used for reasons of convenience and are not to be interpreted as limiting. The terms “right”, “left”, “top”, and “bottom” refer to directions in the figures. The terminology comprises the explicitly mentioned terms as well as their derivations and terms with a similar meaning.

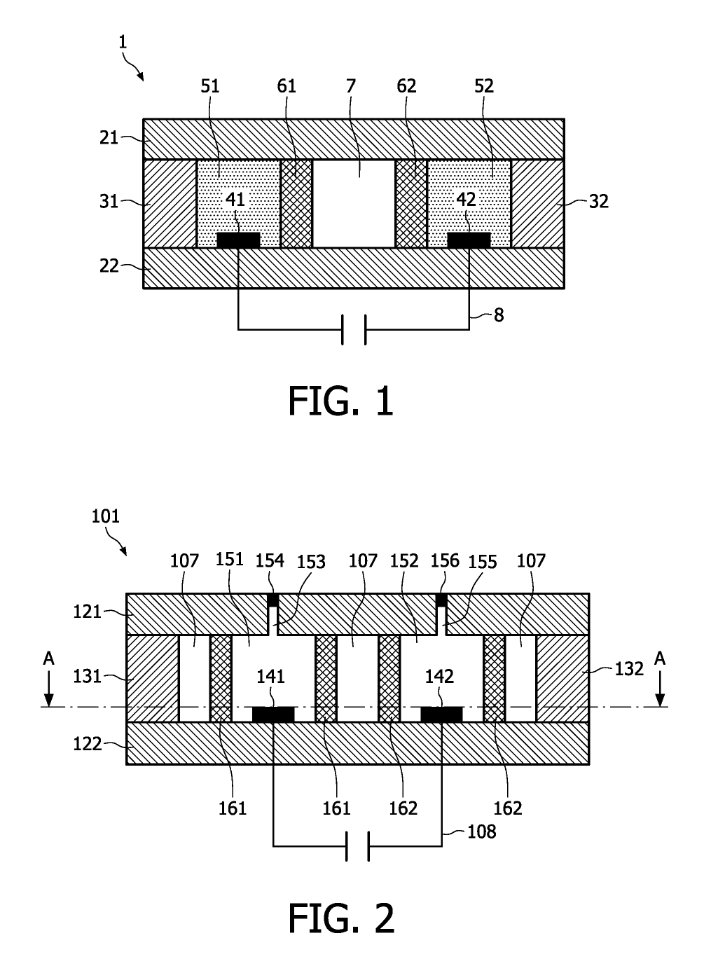

FIG. 1 shows a schematic cross sectional view of a first embodiment of a micro system power supply 1 having a compartment 7, a first ion sink void 51 and a second ion sink void 52. The first ion sink void 51 and the second ion sink void 52 are separated from the compartment 7 by ion pervious separations means comprising an anion exchange membrane 61 and a cation exchange membrane 62. In more detail, the first ion sink void 51 is separated from the compartment 7 by the anion exchange membrane 61 and the second ion sink void 52 is separated from the compartment 7 by the cation exchange membrane 62.

The micro system power supply 1 further comprises a housing with a top first plate 21, a bottom second plate 22 and a space holder from which a left portion 31 and a right portion 32 are visible in FIG. 1. The first ion sink void 51 is delimited by the top plate 21, the bottom plate 22, the anion exchange membrane 61, and the left portion 31 of the space holder. The top plate 21 as well as the bottom plate 22 can, e.g., be made of glass. The second ion sink void 52 is delimited by the top plate 21, the bottom plate 22, the cation exchange membrane 62, and the right portion 32 of the space holder. In the interior of the first ion sink void 51 as well as in the interior of the second ion sink void 52 an ion sink medium is arranged, e.g., a low ionogenic liquid such as ion poor water or de-ionized water or distilled water. In certain applications also tap water or rain water can be suitable.

Furthermore, at the bottom of the first ion sink void 51 a first electrode 41 is arranged in the ion sink void 51 and at the bottom of the second ion sink void 52 a second electrode 42 is arranged in the ion sink void 52. The first electrode 41 and the second electrode 42 are connected to an electrical circuit 8.

The micro system power supply 1 can, e.g., be manufactured using hydrophobic/hydrophilic patterning for the formation of the line structured ion pervious separation means. To form the membrane areas patterning of one glass plate out of the top plate 21 and the bottom plate 22 is sufficient. First, the glass plate is masked in the areas where polymeric membranes, i.e. the anion exchange membrane 61 and the cation exchange membrane 62, will be formed. Standard lithography or also simple coverage by adhesive tape can be used for this purpose. Then a UV-ozone treatment is applied before 1H,1H-2H,2H-perfluorodecyltrichlorosilane (Repel silane') is evaporated to form hydrophobic areas. After removal of the masking material, a cell is formed by placing the patterned glass plate on top of the second plate, i.e. either the top plate 21 or the bottom plate 22. The space holder keeps the substrates at a distance, wherein adhesive tape, e.g. having a thickness of about 50 micrometer, or lithographic spacers can be used as space holder. Subsequently, the hydrophilic areas are filled with cationic and anionic monomer mixtures and these are then polymerized. This results in the formation of polymer networks containing respectively anionic and cationic side groups such that the anion exchange membrane 61 and the cation exchange membrane 62 are formed.

This principle can, e.g., be implemented using acrylamide monomers to form the polymer membranes. The cation exchange membrane 62 can be made from acrylamidomethylpropanesulfonicacid sodium salt solution and the anion exchange membrane 61 can be made from acrylamidopropyltrimethylammonium chloride salt solution (about 10 to about 50 or in certain cases even to about 100 wt % monomer). The monomers can be crosslinked with bisacrylamide (in the range of about 1:10 to about 1:100) to form a polymer network. The presence of a relatively large amount of water in the monomer mix (up to 90% is feasible) can yield an open polymer network which enhances the diffusion of ions through the network. A photoinitiator (Irgacure 2959, 2 wt %) can be added to make the solution photo-polymerizable but also thermal initiation can be used.

Furthermore, to enhance stability of the device, the membrane areas can be coated with an adhesive layer to (chemically) bind the polymer membranes to the glass plate. Thereto, methacryloxypropyltrimethoxysilane (Bind silane') can be evaporated on both the top plate 21 and the bottom plate 22 before the hydrophilic/hydrophobic patterning steps described above are performed. The methacrylate functionalities can be used to form covalent bonds between the glass and the membrane materials.

Since the anion exchange membrane 61 as well as the cation exchange membrane 62 are somewhat sensitive for water transport to the compartment 7, the use of hydrophobic surfaces as described can assist to prevent undesired filling of the compartment 7 during storage (prior to the use) of the micro system power supply 1.

The following performed and measured examples demonstrate in more detail possible realizations of the manufacturing of the micro system power supply 1 as described above.

### Example 1

(i) glass plate cleaning with soap Extran 02 (by Merck), rinsing and blow-drying;
(ii) masking of top glass plate with two membrane areas of approx. 50×2 mm2 with adhesive tape (Scotch tape) wherein the distance between the membrane areas is about 4 mm (compartment area approx 50×4 mm2);
(iii) providing UV-ozone UVP-100 for 10 minutes;
(iv) depositing 1H,1H-2H,2H-perfluorodecyltrichlorosilane (ABCR) in desiccator (1 mBar) for 1 hour;
(v) removing Scotch tape;
(vi) applying 50 micrometer spacers (Scotch tape) on bottom glass plate and putting top glass plate on top;
(vii) filling of membranes areas;
(viii) cation exchange membrane built from water, 25 wt % sodium acrylamidomethylpropanesulfonicacid, bis-acrylamide
(monomer/crosslinker ratio 50:1), 2 wt % photoinitiator Irgacure 2959;
(ix) anion exchange membrane built from water, 25 wt % acrylamidopropyltrimethylammonium chloride, bis-acrylamide (monomer/crosslinker ratio 50:1), 2 wt % photoinitiator Irgacure 2959; and
(x) UV-exposuring (Philips PL-10, 3 mWcm⁻²) in N₂-chamber for 15 minutes.

Thereby, the capillary in between the membranes are filled with 10 μl 1M NaCl and on the outer sides of the membranes droplets of deionized water are dispensed. Cu-electrodes are brought in contact with the deionized water solution and the voltage across the electrodes is measured. The device generates a potential difference of approximately 300 mV that slowly reduces. After one hour it still is 100 mV.

### Example 2

In a second example the micro system power supply is loaded with urine. The micro system power supply generates a potential difference of approximately 80 mV.

### Example 3

A third micro system power supply similar to the micro system power supply described in example 1, except:
(viii) cation exchange membrane built from water, 50 wt % sodium acrylamidomethylpropanesulfonicacid, bis-acrylamide (monomer/crosslinker ratio 50:1), 2 wt % photoinitiator Irgacure 2959; and
(ix) anion exchange membrane built from water, 50 wt % acrylamidopropyltrimethylammonium chloride, bis-acrylamide (monomer/crosslinker ratio 50:1), 2 wt % photoinitiator Irgacure 2959, is loaded with 1M NaCl solution. At the outer sides of the membranes droplets of tap water are dispensed. The micro system power supply generates a potential difference of approximately 300 mV.

### Example 4

A micro system power supply similar to the device described in example 3 is loaded with 1M NaCl solution. At the outer sides of the membranes droplets of tap water are dispensed. The device generates a potential difference of approximately 250 mV.

### Example 5

The following 5-layer micro system power supply rack is formed:
(i) paper sheet filled with deionized water;
(ii) cation exchange membrane built from water, 25 wt % sodium acrylamidomethylpropanesulfonicacid, bis-acrylamide (monomer/crosslinker ratio 100:1), 2 wt % photoinitiator Irgacure 2959 and UV cured for 30 min with a Philips PL-10, (3 mWcm⁻²) UV-source in an N₂-chamber with a thickness of approximately 0.5 mm;
(iii) paper sheet filled with 1M NaCl solution;
(iv) cation exchange membrane built from water, 25 wt % acrylamidopropyltrimethylammonium chloride, bis-acrylamide (monomer/crosslinker ratio 100:1), 2 wt % photoinitiator Irgacure 2959 and UV cured for 30 min with a Philips PL-10, (3 mWcm⁻²) UV-source in an N₂-chamber with a thickness of approximately 0.5 mm;
(v) paper sheet filled with deionized water.

Effective membrane surface area, i.e. the area at one side of the membrane that contacts the adjacent liquid containing layer, is approximately 3×3 cm². Cu-electrodes are contacted to both outer paper sheets and the voltage as well as the generated current is measured. The stack generates a potential difference of maximal 0.5 V and maximal 20 μA.

In operation, the micro system power supply 1 is connected to a micro system such as, e.g., a microfluidic system, a MEMS, a bioMEMS, or an implantable micro device, via the electrical circuit 8. For supplying power to the micro system a suitable liquid, such as, e.g., a bio-liquid as urine or blood, or another ion-rich liquid, is provided to the compartment 7. The liquid can either be arranged inside the compartment 7 or the compartment 7 can be flushed by the liquid. As soon as the liquid is in the compartment 7, power generated by a reverse electrodialysis process is provided to the micro system via the first electrode 41, the second electrode 42, and the electrical circuit 8. The reverse electrodialysis process is driven by the tendency of reducing the difference between the salt concentrations in the compartment 7 and in the first ion sink void 41 and the second ion sink void 42, respectively. Thereby, anions pass the anion exchange membrane 61 into the first ion sink void 51 and cations pass the cation exchange membrane 62 into the second ion sink void 52. In this way, a difference between chemical potentials of the ion concentration of the ion sink medium in the first ion sink void 51 and the ion concentration of the ion sink medium in the second ion sink void 52 is provided.

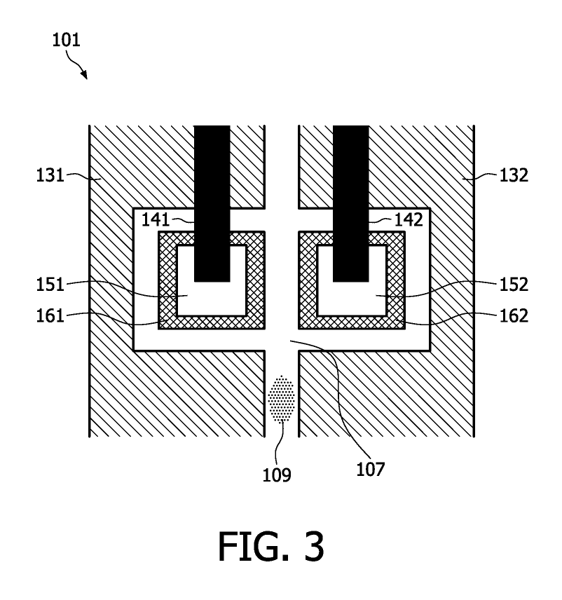

In FIG. 2 and in FIG. 3 schematic cross sectional views of a second embodiment of a micro system power supply 101 having a compartment 107, a first ion sink void 151 and a second ion sink void 152 is shown. The first ion sink void 151 and the second ion sink void 152 are separated from the compartment 107 by ion pervious separations means comprising an anion exchange membrane 161 and a cation exchange membrane 162. In more detail, the first ion sink void 151 is separated from the compartment 107 by the anion exchange membrane 161 and the second ion sink void 152 is separated from the compartment 107 by the cation exchange membrane 162.

The micro system power supply 101 further comprises a housing with a top first plate 121, a bottom second plate 122 and a space holder from which a left portion 131 and a right portion 132 are visible in FIG. 2 and in FIG. 3. The first ion sink void 151 is encapsulated by the anion exchange membrane 161 and the second ion sink void 152 is encapsulated by the cation exchange membrane 162. Thereby, the compartment 107 is arranged surrounding the first ion sink void 151 and surrounding the second ion sink void 152. The first ion sink void 151 has an inlet 153 extending though the top plate 121 and being accessible from outside of the micro system power supply 101. Correspondingly, the second ion sink void 152 has an inlet 155 extending though the top plate 121 and being accessible from outside of the micro system power supply 101. The inlet 153 of the first ion sink void 151 is sealed by a closure 154 and the inlet 155 of the second ion sink void 155 is sealed by a closure 156.

At the bottom of the first ion sink void 151 a first electrode 141 is arranged in the first ion sink void 151 and at the bottom of the second ion sink void 152 a second electrode 142 is arranged in the second ion sink void 152. The first electrode 141 and the second electrode 142 are connected to an electrical circuit 108. At the location of the compartment 107 the first electrode 141 and the second electrode 142 are shielded from the ionogenic liquid in the compartment 107 by a thin dielectric layer avoiding electrical contact between the first electrode 141 and the second electrode 142 and the ionogenic liquid. The dielectric layer can be a vacuum processed silicon oxide layer. But it can also be made from a thin plastic coating based on a photopolymerized acrylic resin. Furthermore, a salt 109 is arranged inside the compartment 107. Examples of suitable salts 109 are sodium chloride, potassium fluoride, sodium sulfate, potassium nitrate, ammonium chloride, but can be any other salt 109 that is dissolvable in water.

Operation of the micro system power supply 101 can be performed essentially corresponding to the operation of the micro system power supply 1 described above wherein, prior to providing the liquid into the compartment 107, an ion sink liquid is provided to the first ion sink void 151 and to the second ion sink void 152. The ion sink medium can be clean water, such as, e.g., tap water or rain water as well as an ion poor liquid. By providing the liquid into the compartment 107, the salt 109 is dissolved in the liquid such that the salt concentration in the compartment 107 is increased.

While the invention has been illustrated and described in detail in the drawings and foregoing description, such illustration and description are to be considered illustrative or exemplary and not restrictive; the invention is not limited to the disclosed embodiments. For example, it is possible to operate the invention in an embodiment wherein the at least one ion sink void can be arranged as a porous membrane filled with an ion poor liquid such as, e.g., deionized water.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single unit may fulfill the functions of several items recited in the claims. The mere fact that certain measures are recited in mutually different dependent claims does not indicate that a combination of these measured cannot be used to advantage. Any reference signs in the claims should not be construed as limiting the scope.

1. A micro system power supply (1; 101) comprising
a compartment (7; 107);
at least one ion sink void (51, 52; 151, 152) being separated from the compartment (7; 107) by ion pervious separation means (61, 62; 161, 162);
a first electrode (41; 141) being arranged in the at least one ion sink void (51, 52; 151, 152); and
a second electrode (42; 142).

2. The micro system power supply (1; 101) of claim 1, wherein
the ion pervious separation means (61, 62; 161, 162) comprise an anion exchange membrane (61; 161) and a cation exchange membrane (62; 162);
the at least one ion sink void (51, 52; 151, 152) comprises a first ion sink void (51; 151) and a second ion sink void (52; 152);
the first ion sink void (51; 151) is separated from the compartment (7; 107) by the anion exchange membrane (61; 161); and
the second ion sink void (52; 152) is separated from the compartment (7; 107) by the cation exchange membrane (62; 162).

3. The micro system power supply (1; 101) of claim 2, wherein the first electrode (41; 141) is arranged in the first ion sink void (51; 151) and the second electrode (42; 142) is arranged in the second ion sink void (52; 152).

4. The micro system power supply (1; 101) of claim wherein the anion exchange membrane (61; 161) and the cation exchange membrane (62; 162) are arranged on opposite sides of the compartment (7; 107).

5. The micro system power supply (1; 101) of claim 1, wherein an ion sink medium is arranged in the at least one ion sink void (51, 52; 151, 152).

6. The micro system power supply (1; 101) of claim 1, wherein the at least one ion sink void (51, 52; 151, 152) comprises an inlet (153, 155) for receiving an ion sink medium.

7. The micro system power supply (1; 101) of claim 5, wherein the ion sink medium is a low ionogenic liquid.

8. The micro system power supply (1; 101) of claim 1, comprising an electrical circuit (8; 108) being connected to the first electrode (41; 141) and to the second electrode (42; 142).

9. The micro system power supply (1; 101) of claim 1, comprising a first plate (21; 121), a second plate (22; 122) and a space holder (31, 32; 131, 132) being arranged between the first plate (21; 121) and the second plate (22; 122), wherein the compartment (7; 107), the at least one ion sink void (51, 52; 151, 152), the ion pervious separation means (61, 62; 161, 162), the first electrode (41; 141), and the second electrode (42; 142) are arranged in the interior formed by the first plate (21; 121), the second plate (22; 122) and the space holder (31, 32; 131, 132).

10. The micro system power supply (1; 101) according to claim 1, wherein the at least one ion sink void (51, 52; 151, 152) is encapsulated by the ion pervious separation means (61, 62; 161, 162) and the compartment (7; 107) is surrounding the at least one ion sink void (51, 52; 151, 152).

11. The micro system power supply (1; 101) according to claim 1, wherein the ion pervious separation means (61, 62; 161, 162) have an uneven structured surface facing the compartment (7; 107).

12. The micro system power supply (1; 101) according to claim 1, comprising a plurality of compartments (7; 107), a plurality of at least one ion sink voids (51, 52; 151, 152), a plurality of ion pervious separation means (61, 62; 161, 162), a plurality of first electrodes (41; 141), and a plurality of second electrodes (42; 142).

13. The micro system power supply (1; 101) according to claim 1, comprising a salt (109) being arranged in the compartment (7; 107).

14. A method of supplying power to a micro system, comprising the steps of:
(i) providing a compartment (7; 107) being separated from at least one ion sink void (51, 52; 151, 152) by ion pervious separation means (61, 62; 161, 162);
(ii) providing a first electrode (41; 141) in the at least one ion sink void (51, 52; 151, 152) and a second electrode (42; 142) contacting a reference;
(iii) providing an electrical circuit (8; 108) connecting the first electrode (41; 141) and the second electrode (42; 142);
(iv) providing an ion sink medium into the at least one ion sink void (51, 52; 151, 152);
(v) connecting the electrical circuit (8; 108) to the micro system; and
(vi) providing a bio-liquid into the compartment (7; 107).

15. The method of claim 14, wherein salt (109) is arranged in the compartment (7; 107) before the bio-liquid is provided into the compartment (7; 107).
